(19) United States
(12) Patent Application Publication
(10) Pub. No.: US 2023/0199143 A1
(43) Pub. Date: Jun. 22, 2023

(54) VIDEO STORAGE METHOD AND APPARATUS, AND SOC SYSTEM AND MEDIUM

(71) Applicant: INSPUR (BEIJING) ELECTRONIC INFORMATION INDUSTRY CO., LTD, Beijing (CN)

(72) Inventors: Zhenlei ZHANG, Beijing (CN); Tongqiang LIU, Beijing (CN); Yulong ZHOU, Beijing (CN); Yuanman TONG, Beijing (CN)

(21) Appl. No.: 18/008,381

(22) PCT Filed: Feb. 20, 2021
(86) PCT No.: PCT/CN2021/077020

§ 371 Date: Dec. 5, 2022

(30) Foreign Application Priority Data
Jun. 12, 2020 (CN) 202010540164.9

(51) Int. Cl. H04N 5/765; H04N 5/907; H04N 9/67; G06F 3/06

(52) U.S. Cl. CPC H04N 5/765; G06F 3/0604; G06F 3/0638; G06F 3/0673; H04N 5/907; H04N 9/67

(57) ABSTRACT

A video storage method and apparatus, and a system on chip (SOC) system and a medium. The method includes: according to video information to be stored and occupation information of a target double data rate (DDR), sending a storage space application request to the target DDR (S11); receiving a storage space allocation response sent by the target DDR according to the storage space application request (S12); and storing video data to be stored, which corresponds to the video information to be stored, in an address space which is in the target DDR and corresponds to the storage space application request (S13). By means of the present application, the wasting of a storage space can be avoided, and when video storage is not needed, a storage resource on a SOC system can be used for supporting the operation of other functions.

### CROSS REFERENCE TO RELATED APPLICATION

The present application claims priority to Chinese Patent Application No. 202010540164.9, filed on Jun. 12, 2020 in China National Intellectual Property Administration and entitled “Video Storage Method and Apparatus, and System On Chip (SOC) System and Medium”, which is hereby incorporated by reference in its entirety.

### FIELD

The present application relates to the technical field of data storage, and in particular, to a video storage method and apparatus, and a SOC system and a medium.

### BACKGROUND

In a conventional System on Chip (SOC) system integrated with a video compression function, spaces with continuous addresses will be allocated in a corresponding off-chip Double Data Rate (DDR) to store source video data or compressed video data in advance. Such storage spaces cannot be released when the SOC system disables a video function, which will affect the operation of functions of the SOC system for the SOC system with the shortage of memory resources. In addition, video storage spaces on the SOC system need to be used in scenarios with different resolutions. For security, the requirement of the maximum resolution (such as 1920x1024) needs to be met, so a large storage space will generally be allocated. However, if the resolution of a video to be stored is low in an application of the SOC system, such as 640x480, then a large part of the DDR space will be wasted, resulting in a waste of storage resources.

### SUMMARY

In view of this, an objective of the present application is to provide a video storage method and apparatus, and a SOC system and a medium, which can avoid the waste of storage resources on the SOC system and ensure normal operation of functions of the SOC system. The certain solution is as follows:

In a first aspect, the present application discloses a video storage method, which is applied to a SOC system, and includes:
according to video information to be stored and occupation information of a target DDR, sending a storage space application request to the target DDR;
receiving a storage space allocation response sent by the target DDR according to the storage space application request; and
storing video data to be stored, which corresponds to the video information to be stored, in an address space which is in the target DDR and corresponds to the storage space application request.

In some embodiments, the step of according to the video information to be stored and the occupation information of the target DDR, sending the storage space application request to the target DDR includes:
in response to the video data to be stored being source video data, sending the storage space application request to the target DDR according to a resolution of the video to be stored, a number of frames of the video to be stored, and the occupation information of the target DDR; and
in response to the video data to be stored being compressed video data, sending the storage space application request to the target DDR according to the resolution of the video to be stored, the number of frames of the video to be stored, compression mode configuration, and the occupation information of the target DDR.

In some embodiments, the step of sending the storage space application request to the target DDR includes:

in response to the video data to be stored being the source video data, sending the storage space application request to the target DDR by a local central processing unit (CPU). A size of the storage space applied by the storage space application request is determined according to a resolution and a number of frames of the video data to be stored.

Correspondingly, the step of storing the video data to be stored, which corresponds to the video information to be stored, in the address space which is in the target DDR and corresponds to the storage space application request includes:
sending, by the local CPU, a starting address corresponding to the storage space application request, the number of frames of the video data to be stored, and the resolution of the video data to be stored to a local source video data writing control module; and
storing, by the local source video data writing control module, the video data to be stored in the address space corresponding to the starting address.

In some embodiments, the step of sending the storage space application request to the target DDR includes:

in response to the video data to be stored being the compressed video data, sending the storage space application request to the target DDR by a local CPU. The size of the storage space applied by the storage space application request is determined according to the resolution of the video data to be stored, the number of frames of the video data to be stored, and the compression mode configuration.

Correspondingly, the step of storing the video data to be stored, which corresponds to the video information to be stored, in the address space which is in the target DDR and corresponds to the storage space application request includes:
sending, by the local CPU, a starting address corresponding to the storage space application request and the number of frames of the video data to be stored to a local compressed video data writing control module; and
storing, by the local compressed video data writing control module, the video data to be stored in the address space corresponding to the starting address.

In some embodiments, before the step of sending the storage space application request to the target DDR by the local CPU, the method further includes:
reading, by the local CPU, the resolution of the video data to be stored from a local video card;
or, reading, by the local CPU, the resolution of the video data to be stored from a local resolution detection module.

In some embodiments, before the step of storing, by the local source video data writing control module, the video data to be stored in the address space corresponding to the starting address, the method further includes:

performing, by a local color space conversion module, color space conversion on the video data to be stored, so as to obtain the video data to be stored after conversion.

In some embodiments, the video storage method further includes:
disabling a local video function in response to a video function disabling command being received; and
stopping applying for the storage space from the target DDR, whereby the target DDR is locally called to support a running application,

In a second aspect, the present application discloses a video storage apparatus, which is applied to a SOC system, and includes:
a request sending module, configured to send, according to video information to be stored and occupation information of a target DDR, a storage space application request to the target DDR;
an information receiving module, configured to receive a storage space allocation response sent by the target DDR according to the storage space application request; and
a data storage module, configured to store video data to be stored, which corresponds to the video information to be stored, in an address space which is in the target DDR and corresponds to the storage space application request.

In a third aspect, the present application discloses a SOC system, including:

a memory and a processor.

The memory is configured to store a computer instruction.

The processor is configured to execute the computer instruction to implement the video storage method of the foregoing disclosure.

In a fourth aspect, the present application discloses a computer-readable storage medium for storing a computer instruction. The computer instruction is executed by a processor to implement the video storage method of the foregoing disclosure.

It can be seen that, according to the present application, first, a storage space application request is sent to the target DDR according to video information to be stored and occupation information of a target DDR, and storage space allocation response sent by the target DDR according to the storage space application request is received; and then, the video data to be stored, which corresponds to the video information to be stored, is stored in an address space which is in the target DDR and corresponds to the storage space application request. By means of the present application, in a video storage process, first, the storage space is applied according to the video information to be stored and an occupation condition of the DDR to be written, and then, the video to be stored is stored in the applied space, whereby the wasting of the storage space can be avoided, and when video storage is not needed, a storage resource on the SOC system can be used for supporting the normal operation of other functions on the system, and the performance of the SOC system is improved.

### BRIEF DESCRIPTION OF THE DRAWINGS

In order to illustrate the embodiments of the present application or the technical solutions in the prior art more clearly, the drawings that need to be used in the description of the embodiments or the prior art will be briefly described below. It is apparent that the drawings in the following description are only embodiments of the present application, and other drawings can be obtained by those skilled in the art according to the provided drawings without creative work.

FIG. 1 is a flowchart of a video storage method disclosed by the present application;

FIG. 2 is a video storage block diagram disclosed by the present application;

FIG. 3 is a flowchart of a certain video storage method disclosed by the present application;

FIG. 4 is a schematic diagram of compression mode configuration disclosed by the present application;

FIG. 5 is a schematic structural diagram of a video storage apparatus disclosed by the present application; and

FIG. 6 is a schematic structural diagram of a SOC system disclosed by the present application

### DETAILED DESCRIPTION

The technical solutions in the embodiments of the disclosure are clearly and completely described in the following with reference to the accompanying drawings in the embodiments of the disclosure. It is apparent that the described embodiments are merely a part of the embodiments of the disclosure, but not all of the embodiments. All other embodiments obtained by those of ordinary skill in the art based on the embodiments of this application without creative efforts shall fall within the scope of protection of this application.

At present, in a SOC system integrated with a video compression function, spaces with continuous addresses will be allocated in a corresponding off-chip DDR to store source video data or compressed video data in advance. Such pre-allocation of a storage space can result in loss of flexibility in video data storage, whereby the waste of storage resources is caused, and the normal operation of functions of the SOC system is affected. In view of this, the present application provides a video storage method, which can avoid the waste of storage resources on the SOC system and ensure the normal operation of the functions of the SOC system.

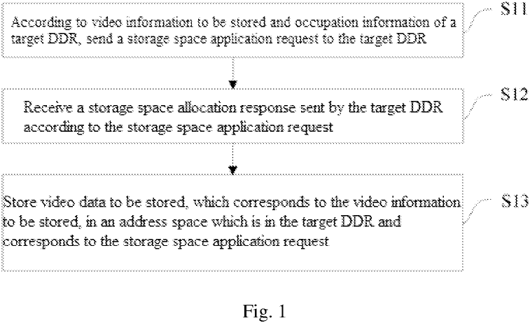

Referring to FIG. 1, the embodiment of the present application discloses a video storage method, which is applied to a SOC system. The method includes the following steps.

At S11: according to video information to be stored and occupation information of a target DDR, a storage space application request is sent to the target DDR.

In certain embodiment, the storage space application request needs to be sent to the target DDR first according to the video information to be stored and the occupation information of the target DDR. The target DDR is a local corresponding DDR that can be configured to write local data to be stored. When video data to be stored is source video data, the video information to be stored includes the resolution and the number of frames of the video to be stored. When the video data to be stored is compressed video data, the video information to be stored includes the resolution and the number of frames of the video to be stored, and compression mode configuration. The storage space application request may include a starting address of a local storage space to be applied, and the resolution and the number of frames of a video to be stored. The starting address may be determined according to the occupation information of the target DDR.

At S12: a storage space allocation response sent by the target DDR according to the storage space application request is received.

After sending the storage space application request, if the storage space corresponding to the storage space application request is allocated successfully, then the target DDR returns a corresponding response. Therefore, the storage space allocation response sent by the target DDR according to the storage space application request needs to be received locally. If the storage space is allocated unsuccessfully, then a new address space needs to be applied.

At S13: the video data to be stored, which corresponds to the video information to be stored, is stored in an address space which is in the target DDR and corresponds to the storage space application request.

After receiving the storage space allocation response, the video data to be stored, which corresponds to the video information to be stored, is stored in an address space which is in the target DDR and corresponds to the storage space application request.

It can be seen that, according to the present application, first, a storage space application request is sent to the target DDR according to video information to be stored and occupation information of a target DDR, and storage space allocation response sent by the target DDR according to the storage space application request is received; and then, the video data to be stored, which corresponds to the video information to be stored, is stored in an address space which is in the target DDR and corresponds to the storage space application request. By means of the present application, in a video storage process, first, the storage space is applied according to the video information to be stored and an occupation condition of the DDR to be written, and then, the video to be stored is stored in the applied space, whereby the wasting of the storage space can be avoided, and when video storage is not needed, a storage resource on the SOC system can be used for supporting the normal operation of other functions on the system, and the performance of the SOC system is improved.

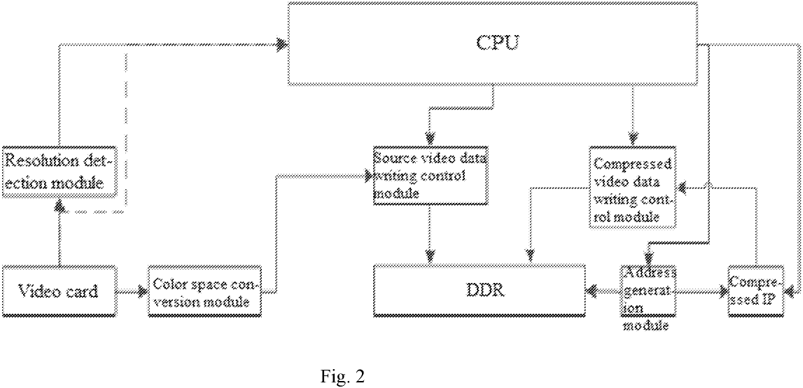

Referring to FIG. 2, the embodiments of the present application disclose a certain video storage block diagram, which includes: a video card, a color space conversion module, a DDR, a source video data writing space module, a compressed video data writing space module, an address generation module, a compressed Intellectual Property core (i.e., IP core), and a CPU, and may further include a resolution detection module.

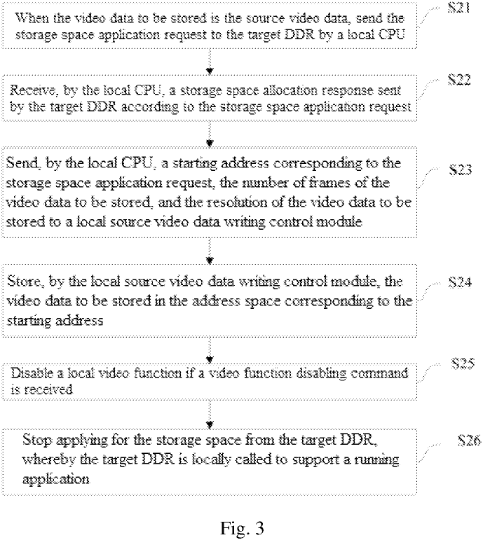

The video storage method provided by the present application is described in combination with FIG. 2. Referring to FIG. 3, the embodiments of the present application disclose a certain video storage method, which is applied to a SOC system. The method includes the following steps.

At S21: when the video data to be stored is the source video data, the storage space application request is sent to the target DDR by a local CPU. The size of the storage space applied by the storage space application request is determined according to the resolution and the number of frames of the video data to be stored.

In certain embodiment, the storage space application request may be sent to the target DDR first. That is, the storage space application request is sent to the target DDR by the local CPU. The storage space application request is sent to the target DDR by corresponding software running on the local CPU.

In certain embodiment, when the video data to be stored is the source video data, the storage space application request is sent to the target DDR by the local CPU. The size of the storage space applied by the storage space application request is determined according to the resolution and the number of frames of the video data to be stored. The starting address of the applied storage space may be determined according to the occupation condition of the target DDR.

At S22: a storage space allocation response sent by the target DDR according to the storage space application request is received by the local CPU.

It can be understood that, after sending the storage space application request, the storage space allocation response sent by the target DDR according to the storage space application request further needs to be received by the local CPU.

At S23: a starting address corresponding to the storage space application request, the number of frames of the video data to be stored, and the resolution of the video data to be stored are sent to a local source video data writing control module by the local CPU.

After receiving the storage space allocation response sent by the target DDR according to the storage space application request, relevant information is sent to the local source video data writing control module by the local CPU, whereby the local source video data writing control module writes the video data to be stored into the target DDR according to the received relevant information.

In certain embodiment, since videos are output continuously, and storage space address information is also issued continuously, three First Input First Outputs (FIFOs) may be set inside the local source video data writing control module: WR_ADDR_FIFO, WR_FRAME_NUM_FIFO, and RSL_FIFO, which respectively store the starting address, the number of frames stored, and the resolution. Then, the local source video data writing control module reads the WR_ADDR_FIFO, the WR_FRAME_NUM_FIFO, and the RSL_FIFO in sequence, whereby a set of storage space address information can be obtained. If it is represented by registers WR_ADDR, WR_FRAME_NUM, and RSL, then the first register WR_ADDR is the first address of the DDR to be written, the second register WR_FRAME_NUM is the number of frames to be written in a DDR space which takes the WR_ADDR as the starting address, and the third register RSL is resolution information.

At S24: the video data to be stored is stored in the address space corresponding to the starting address by the local source video data writing control module.

After the local source video data writing control module obtains the starting address, the resolution, and the number of frames, the video data to be stored may be stored in the address space corresponding to the starting address by the local source video data writing control module.

Before storing the source video data to the target DDR, the method further includes: performing, by a local color space conversion module, color space conversion on the video data to be stored, so as to obtain the video data to be stored after conversion. RGB data is converted into YUV data and is sent to the local source video data writing control module. An RGB color mode is a color standard in industry, which obtains a variety of colors through the change of three color channels of red (R), green (G) and blue (B) and their superposition, and is one of the most widely used color systems at present. YUV is a color coding method, Y represents brightness, U represents chroma, and V represents concentration.

The local source video data writing control module reads the information in the three registers WR_ADDR, WR_FRAME_NUM, and RSL to obtain a set of storage space address information. The corresponding video data to be stored is stored in the address space. For example, the set of storage space address information read is that the value of the register WR_ADDR is 0×1000_0000, and the value of the WR_FRAME_NUM is 2, then 2 frames of image information is to be written in the space with 0×1000_000 as the starting address on the DDR. The resolution is used for calculating the number of frames written to the target DDR video, for example, taking the resolution of 640×480 as an example, the data written to the target DDR is counted as wr_cnt at the local source video data writing control module, and when wr_cnt= 640×480×2, it indicates that two frames of source video data are written. After the storage of the two frames of videos is ended, the local CPU may send a storage space application request to the target DDR again according to the video information to be stored next and an occupation condition of the target DDR, until the storage of the source video data to be stored is completed or the storage space of the target DDR is insufficient.

Thus, the storage space may be applied flexibly according to the using condition of the DDR space, and then a space address is issued to the local source video data writing control module for storing data, which can maximize the use efficiency of the DDR. Meanwhile, when the SOC system disables a video function, the DDR space is not applied for, and all DDR space is used for other functions of the SOC, whereby the performance of the SOC system is improved.

Before sending the storage space application request to the target DDR by the local CPU, the method further includes: reading the resolution of the video data to be stored from a local video card by the local CPU; or, reading the resolution of the video data to be stored from a local resolution detection module by the local CPU. If the video card has a register that stores the resolution of the video data to be stored, then the local CPU may directly read the resolution corresponding to the video data to be stored from the video card. At this moment, the resolution detection module is not needed. The process at this moment is shown as a dotted line in FIG. 2. If the video card does not have a register that stores the resolution of the video data to be stored, then source video control information of the video card needs to be input to the resolution detection module. The source video control information includes rows such as Hs and Vs, and field synchronization control information, so as to detect the resolution.

Correspondingly, when the video data to be stored is the compressed video data, the storage space application request is sent to the target DDR by the local CPU. The size of the storage space applied by the storage space application request is determined according to the resolution of the video data to be stored, the number of frames of the video data to be stored, and the compression mode configuration. For the source video data with the same number of frames and the same resolution, the sizes of the storage spaces required by the compressed video data are also different due to different compression mode configuration. For example, for the source video data with the same number of frames and the same resolution, the storage space required by the compressed video data adopting the compression mode configuration of YUV420 is smaller than that required by the compressed video data adopting the compression mode configuration of YUV444. For the compression mode configuration of YUV420, every four Ys share a group of UV components; and for the compression mode configuration of YUV444, each Y corresponds to a group of UV components, Y represents brightness, U represents chroma, and V represents concentration. Therefore, part of UV components will be discarded for the compression mode configuration of YUV420.

The starting address corresponding to the storage space application request and the number of frames of the video data to be stored are sent to a local compressed video data writing control module by the local CPU. The video data to be stored is stored to the address space corresponding to the starting address by the local compressed video data writing control module.

In certain embodiment, since videos are output continuously, and storage space address information is also issued continuously, there may be two FIFOs inside the local compressed video data writing control module: WR_ADDR_FIFO and WR_FRAME_NUM_FIFO, which respectively store the starting address and the number of frames stored. Then, the local compressed video data writing control module reads the R_ADDR_FIFO and the WR_FRAME_NUM_FIFO in sequence, whereby a set of storage space information can be obtained. If it is represented by registers WR_ADDR and WR_FRAME_NUL, then the first register WR_ADDR is the starting address of the DDR to be written, the second register WR_FRAME_NUM is the number of frames of video images to be written in a DDR space which takes the WR_ADDR as the starting address.

During storing the compressed video data into the target DDR, a set of storage space address information may be read out first, and then the corresponding compressed video data is stored in this set of storage space address information. For example, the set of storage space address information read is that the value of the register WR_ADDR is 0×7000_0000, and the value of the WR_FRAME_NUM is 3, then 3 frames of compressed images are to be written in the storage space with 0×7000_000 as the starting address. During writing the compressed images, the module calculates the number of frames of the images that have been written by using frame header and footer information carried in the compressed images. For example, the header of a frame of image in JPEG format is 0×FFD8 and the footer is 0×FFD9, then writing is stopped when the third footer 0×FFD9 is detected. After the storage of the 3 frames of videos is ended, the local CPU may send a storage space application request to the target DDR again according to the video information to be stored next and an occupation condition of the target DDR, until the storage of the source video data to be stored is completed or the storage space of the target DDR is insufficient.

Before storing the compressed video data to the target DDR, the method further includes: reading out the source video data from the target DDR, and compressing the source video data. The address generation module generates a source video data reading address, and then the source video data is read out from the target DDR according to the source video data reading address by the compressed IP and is compressed. The compressed video data is input to the local compressed video data writing control module.

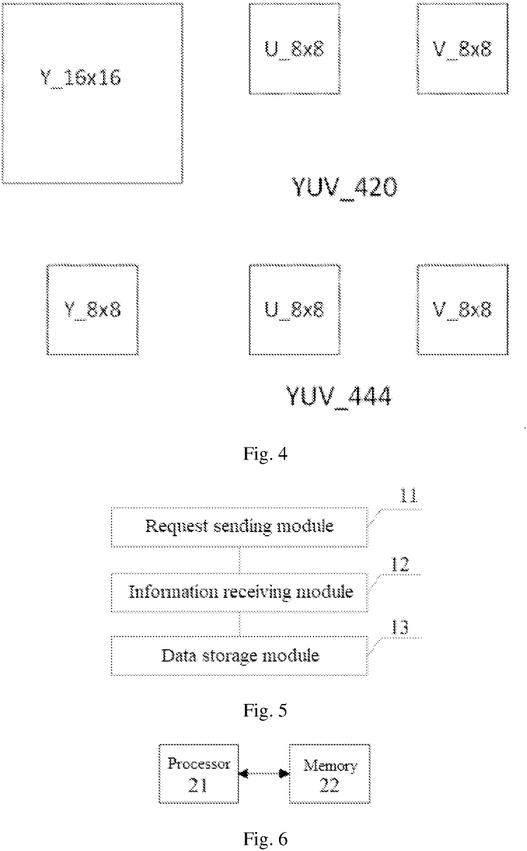

The process that the address generation module generates the source video data reading address includes: generating the source video data reading address by using the storage space address information of the acquired source video data storage, the resolution, and the compression mode configuration. Three FIFOs may be set inside the address generation module: WR_ADDR_FIFO, WR_FRAME_NUM_FIFO, and RSL_FIFO, which respectively store the starting address, the number of frames stored, and the resolution. Three queues are read in sequence to obtain a set of information. After obtaining the starting address of a frame of image, the source video data reading address is generated according to the compression mode configuration. The compression mode configuration includes YUV420 and YUV444 as shown in FIG. 4. YUV420 is to read Y of 16×16 first, then read U of 8×8, then read V of 8×8, and then start to repeat the step of reading Y of 16×16. YUV444 is to read Y of 8×8 first, then read U of 8×8, then read V of 8×8, and then start to repeat the step of reading Y of 8×8. In the WR_ADDR_FIFO, only the starting address of the first frame can be read. If there are a plurality of continuous frames stored at the current address, the starting addresses of the second and subsequent frames are calculated in the module according to the resolution, so as to generate a source video data reading address. For example: the starting address of the second frame is WR_ADDR+RSL_L*RSL_W. The RSL_L and RSL_W are respectively the row and column information of the resolution, for example, RSL_L=640, and RSL_W=480.

At S25: a local video function is disabled if a video function disabling command is received.

In actual application, the local video function is disabled if the video function disabling command is received.

At S26: the application for the storage space from the target DDR is stopped, whereby the target DDR is locally called to support a running application.

After the local video function is disabled, the application for the storage space from the target DDR may be stopped, whereby the target DDR is locally called to support a running application. Normal operation of other functions running locally is ensured, and the performance of the SOC system is improved.

Referring to FIG. 5, the embodiment of the present application discloses a video storage apparatus, which is applied to a SOC system, and includes:
a request sending module 11, configured to send, according to video information to be stored and occupation information of a target DDR, a storage space application request to the target DDR;
an information receiving module 12, configured to receive a storage space allocation response sent by the target DDR according to the storage space application request; and
a data storage module 13, configured to store video data to be stored, which corresponds to the video information to be stored, in an address space which is in the target DDR and corresponds to the storage space application request.

It can be seen that, according to the present application, first, a storage space application request is sent to the target DDR according to video information to be stored and occupation information of a target DDR, and storage space allocation response sent by the target DDR according to the storage space application request is received; and then, the video data to be stored, which corresponds to the video information to be stored, is stored in an address space which is in the target DDR and corresponds to the storage space application request. By means of the present application, in a video storage process, first, the storage space is applied according to the video information to be stored and an occupation condition of the DDR to be written, and then, the video to be stored is stored in the applied space, whereby the wasting of the storage space can be avoided, and when video storage is not needed, a storage resource on the SOC system can be used for supporting the normal operation of other functions on the system, and the performance of the SOC system is improved.

Further, as shown in FIG. 6, the embodiment of the present application further discloses a SOC system, including a processor 21 and a memory 22.

The memory 22 is configured to store a computer program. The processor 21 is configured to execute the computer program to implement the video storage method disclosed by the foregoing embodiments.

A certain process of the abovementioned video storage method can refer to the corresponding contents disclosed by the foregoing embodiments, and will not be elaborated herein.

Further, the embodiment of the present application further discloses a computer-readable storage medium for storing a computer program. The computer program is executed by a processor to implement the video storage method disclosed by any of the foregoing embodiments.

A certain process of the abovementioned video storage method can refer to the corresponding contents disclosed by the foregoing embodiments, and will not be elaborated herein.

Various embodiments in the present specification are described in a progressive manner. Each embodiment focuses on differences from other embodiments, and the same and or similar parts of various embodiments may be referred to one another. The apparatus disclosed by the embodiment is described relatively simply since it corresponds to the method disclosed by the embodiment, and for relevant points may refer to the description of a method section.

The steps of the method or algorithm described in connection with the embodiments disclosed herein can be directly implemented with hardware, a software module executed by a processor, or a combination thereof. The software module can be configured in a random access memory (RAM), a memory, a read-only memory (ROM), an electrically programmable ROM, an electrically erasable programmable ROM, a register, a hard disk, a removable disk, a compact disk (CD)-ROM, or any other form of storage medium known in the technical field.

Finally, it is also to be noted that relational terms such as first and second used merely to distinguish one entity or operation from another entity or operation herein, and do not necessarily require or imply the existence of any such actual relationship or order between these entities or operations. Moreover, the terms “include”, “contain” or any other variations thereof are intended to cover a non-exclusive inclusion, such that a series of processes, methods, articles, or devices including other elements not only include those elements, but also include those elements that are not explicitly listed, or include elements inherent to such processes, methods, articles, or devices. In the absence of more restrictions, elements defined by the phrase “include a/an...” do not exclude the existence of additional identical elements in the process, method, commodity, or device that includes the elements.

The above is a detailed description of a video storage method and apparatus, and SOC system and a medium provided by the embodiments of the present application. The principles and embodiments of the present application are described with certain examples herein. The description of the above embodiments is only for helping to understand the method of the present application and its core ideas. Furthermore, for those of ordinary skill in the art, according to the idea of the present application, there will be changes in certain implementations and application scopes. In conclusion, the above description should not be construed as a limitation to the present application.

1. A video storage method, applied to a system on chip (SOC) system, comprising:
according to video information to be stored and occupation information of a target double data rate (DDR), sending a storage space application request to the target DDR; the video information to be stored is configured to determine a size of a storage space applied by the storage space application request, and the occupation information of the target DDR is configured to determine a starting address corresponding to the storage space application request;
receiving a storage space allocation response sent by the target DDR according to the storage space application request; disabling a local video function in response to a video function disabling command being received; stopping applying for the storage space from the target DDR, whereby the target DDR is locally called to support a running application; and
storing video data to be stored, which corresponds to the video information to be stored, in an address space which is in the target DDR and corresponds to the storage space application request.

2. The video storage method according to claim 1, wherein the step of according to the video information to be stored and the occupation information of the target DDR, sending the storage space application request to the target DDR comprises:
in response to the video data to be stored being source video data, sending the storage space application request to the target DDR according to a resolution of the video data to be stored, a number of frames of the video data to be stored, and the occupation information of the target DDR; and
in response to the video data to be stored being compressed video data, sending the storage space application request to the target DDR according to the resolution of the video data to be stored, the number of frames of the video data to be stored, compression mode configuration, and the occupation information of the target DDR.

3. The video storage method according to claim 2, wherein the step of sending the storage space application request to the target DDR comprises:
in response to the video data to be stored being the source video data, sending the storage space application request to the target DDR by a local central processing unit (CPU), the size of the storage space applied by the storage space application request being determined according to the-a resolution and the-a number of frames of the video data to be stored;
correspondingly, the step of storing the video data to be stored, which corresponds to the video information to be stored, in the address space which is in the target DDR and corresponds to the storage space application request comprises:
sending, by the local CPU, the starting address corresponding to the storage space application request, the number of frames of the video data to be stored, and the resolution of the video data to be stored to a local source video data writing control module; and
storing, by the local source video data writing control module, the video data to be stored in the address space corresponding to the starting address.

4. The video storage method according to claim 2, wherein the step of sending the storage space application request to the target DDR comprises:
in response to the video data to be stored being the compressed video data, sending the storage space application request to the target DDR by a local central processing unit (CPU), the size of the storage space applied by the storage space application request being determined according to the resolution of the video data to be stored, the number of frames of the video data to be stored, and the compression mode configuration;
correspondingly, the step of storing the video data to be stored, which corresponds to the video information to be stored, in the address space which is in the target DDR and corresponds to the storage space application request comprises:
sending, by the local CPU, the starting address corresponding to the storage space application request and the number of frames of the video data to be stored to a local compressed video data writing control module; and
storing, by the local compressed video data writing control module, the video data to be stored to the address space corresponding to the starting address.

5. The video storage method according to claim 3, wherein before the step of sending the storage space application request to the target DDR by the local CPU, the method further comprises:
reading the resolution of the video data to be stored from a local video card by the local CPU;
or, reading the resolution of the video data to be stored from a local resolution detection module by the local CPU.

6. The video storage method according to claim 3, wherein before the step of storing, by the local source video data writing control module, the video data to be stored in the address space corresponding to the starting address, the method further comprises:
performing, by a local color space conversion module, color space conversion on the video data to be stored, so as to obtain the video data to be stored after conversion.

7-8. (canceled)

9. A system on chip (SOC) system, comprising:
a memory and a processor,
wherein the memory is configured to store a computer instruction, and
the processor is configured to execute the computer instruction, and upon execution of the computer instruction, configured to:
according to video information to be stored and occupation information of a target double data rate (DDR), send a storage space application request to the target DDR; the video information to be stored is configured to determine a size of a storage space applied by the storage space application request, and the occupation information of the target DDR is configured to determine a starting address corresponding to the storage space application request;
receive a storage space allocation response sent by the target DDR according to the storage space application request; disable a local video function in response to a video function disabling command being received; stop applying for the storage space from the target DDR, whereby the target DDR is locally called to support a running application; and
store video data to be stored, which corresponds to the video information to be stored, in an address space which is in the target DDR and corresponds to the storage space application request.

10. A computer-readable storage medium, configured to store a computer instruction executable by a processor, and upon execution by the processor, is configured to cause processor to:
according to video information to be stored and occupation information of a target double data rate (DDR), send a storage space application request to the target DDR; the video information to be stored is configured to determine a size of a storage space applied by the storage space application request, and the occupation information of the target DDR is configured to determine a starting address corresponding to the storage space application request;
receive a storage space allocation response sent by the target DDR according to the storage space application request; disable a local video function in response to a video function disabling command being received; stop applying for the storage space from the target DDR, whereby the target DDR is locally called to support a running application; and
store video data to be stored, which corresponds to the video information to be stored, in an address space which is in the target DDR and corresponds to the storage space application request.

11. The video storage method according to claim 1, wherein in response to the storage space being unsuccessfully allocated, applying for an alternative address space.

12. The SOC system according to claim 9, wherein the processor, upon execution of the computer instruction, is further configured to:
in response to the video data to be stored being source video data, send the storage space application request to the target DDR according to a resolution of the video data to be stored, a number of frames of the video data to be stored, and the occupation information of the target DDR; and
in response to the video data to be stored being compressed video data, send the storage space application request to the target DDR according to the resolution of the video data to be stored, the number of frames of the video data to be stored, compression mode configuration, and the occupation information of the target DDR.

13. The SOC system according to claim 12, wherein the processor, upon execution of the computer instruction, is further configured to:
in response to the video data to be stored being the source video data, send the storage space application request to the target DDR by a local central processing unit (CPU), the size of the storage space applied by the storage space application request being determined according to the resolution and the number of frames of the video data to be stored;
correspondingly, the step of storing the video data to be stored, which corresponds to the video information to be stored, in the address space which is in the target DDR and corresponds to the storage space application request comprises:
send the starting address corresponding to the storage space application request, the number of frames of the video data to be stored, and the resolution of the video data to be stored to a local source video data writing control module; and
store the video data to be stored in the address space corresponding to the starting address.

14. The SOC system according to claim 12, wherein the processor, upon execution of the computer instruction, is further configured to:
in response to the video data to be stored being the compressed video data, send the storage space application request to the target DDR by a local central processing unit (CPU), the size of the storage space applied by the storage space application request being determined according to the resolution of the video data to be stored, the number of frames of the video data to be stored, and the compression mode configuration;
correspondingly, the step of storing the video data to be stored, which corresponds to the video information to be stored, in the address space which is in the target DDR and corresponds to the storage space application request comprises:
send the starting address corresponding to the storage space application request and the number of frames of the video data to be stored to a local compressed video data writing control module; and
store the video data to be stored to the address space corresponding to the starting address.

15. The SOC system according to claim 13, wherein the processor, upon execution of the computer instruction, is further configured to:
read the resolution of the video data to be stored from a local video card by the local CPU;
or, read the resolution of the video data to be stored from a local resolution detection module by the local CPU.

16. The SOC system according to claim 13, wherein the processor, upon execution of the computer instruction, is further configured to:
perform color space conversion on the video data to be stored, so as to obtain the video data to be stored after conversion.

17. The SOC system according to claim 9, wherein the processor, upon execution of the computer instruction, is further configured to:
in response to the storage space being unsuccessfully allocated, apply for an alternative address space.

18. The computer-readable storage medium according to claim 10, wherein the computer instruction, upon execution by the processor, is further configured to cause the processor to:
in response to the video data to be stored being source video data, send the storage space application request to the target DDR according to a resolution of the video data to be stored, a number of frames of the video data to be stored, and the occupation information of the target DDR; and
in response to the video data to be stored being compressed video data, send the storage space application request to the target DDR according to the resolution of the video data to be stored, the number of frames of the video data to be stored, compression mode configuration, and the occupation information of the target DDR.

19. The computer-readable storage medium according to claim 18, wherein the computer instruction, upon execution by the processor, is further configured to cause the processor to:
in response to the video data to be stored being the source video data, send the storage space application request to the target DDR by a local central processing unit (CPU), the size of the storage space applied by the storage space application request being determined according to the resolution and the number of frames of the video data to be stored;
correspondingly, the step of storing the video data to be stored, which corresponds to the video information to be stored, in the address space which is in the target DDR and corresponds to the storage space application request comprises:
send the starting address corresponding to the storage space application request, the number of frames of the video data to be stored, and the resolution of the video data to be stored to a local source video data writing control module; and
store the video data to be stored in the address space corresponding to the starting address.

20. The computer-readable storage medium according to claim 18, wherein the computer instruction, upon execution by the processor, is further configured to cause the processor to:
in response to the video data to be stored being the compressed video data, send the storage space application request to the target DDR by a local central processing unit (CPU), the size of the storage space applied by the storage space application request being determined according to the resolution of the video data to be stored, the number of frames of the video data to be stored, and the compression mode configuration;
correspondingly, the step of storing the video data to be stored, which corresponds to the video information to be stored, in the address space which is in the target DDR and corresponds to the storage space application request comprises:
send the starting address corresponding to the storage space application request and the number of frames of the video data to be stored to a local compressed video data writing control module; and
store the video data to be stored to the address space corresponding to the starting address.

21. The computer-readable storage medium according to claim 19, wherein the computer instruction, upon execution by the processor, is further configured to cause the processor to:
read the resolution of the video data to be stored from a local video card by the local CPU;
or, read the resolution of the video data to be stored from a local resolution detection module by the local CPU.

22. The computer-readable storage medium according to claim 19, wherein the computer instruction, upon execution by the processor, is further configured to cause the processor to:
perform color space conversion on the video data to be stored, so as to obtain the video data to be stored after conversion.
